(19) United States
(12) Patent Application Publication
(10) Pub. No.: US 2026/0024003 A1
(43) Pub. Date: Jan. 22, 2026

(54) SYSTEM AND METHOD OF MANAGING LOADING OF MACHINE LEARNING MODELS IN RANDOM ACCESS MEMORY BASED ON USAGE BY SOFTWARE APPLICATIONS

(71) Applicant: Dell Products LP, Round Rock, TX (US)

(72) Inventors: Jacob Mink, Cedar Park, TX (US); Srikanth Kondapi, Austin, TX (US)

(73) Assignee: Dell Products LP, Round Rock, TX (US)

(21) Appl. No.: 18/774,328

(22) Filed: Jul. 16, 2024

(51) Int. Cl. G06N 20/00

(52) U.S. Cl. CPC G06N 20/00

(57) ABSTRACT

An information handling system operating an On the Box (OTB) Artificial Intelligence (AI) productivity tool may comprise a first solid state data storage device for storing a machine learning model, and a hardware processor for executing code instructions of a software application and of a machine learning model access coordination module to receive a request for the software application to access the machine learning model, store the machine learning model in a second random access memory (RAM) data storage device, direct the software application to provide input into the machine learning model, detect a period of time exceeding a machine learning model unloading countdown timer has elapsed since the software application has last provided input values into the machine learning model, and remove the machine learning model from RAM to decrease hardware component resource consumption at the information handling system when the machine learning model is unused.

### FIELD OF THE DISCLOSURE

The present disclosure generally relates to an on the box (OTB) artificial intelligence (AI) productivity tool that employs machine learning models stored at an information handling system for optimizing user productivity and information handling system performance. The present disclosure more specifically relates to automatically managing storage of a given machine learning model within random access memory (RAM) of the information handling system during use of such a machine learning model by an AI productivity tool enableable software application executing locally on the information handling system, and automatically removing the machine learning model from RAM upon determination that the machine learning model is not in use by a locally executing AI productivity tool enableable software application in order to conserve hardware component resource utilization at the information handling system.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workplace productivity software applications such as teleconference software systems, email or messaging software systems, document creation software systems, software monitoring and services systems for operations of an information handling system or other software systems.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system executing computer readable code instructions for an on the box (OTB) artificial intelligence (AI) productivity tool for optimizing user experience and performance of AI productivity tool enableable software applications and hardware components at the information handling system;

FIG. 2 is a block diagram illustrating an OTB AI productivity tool to determine a user intent value and identify and execute a capability having a corresponding intent value, such as operations, software services, or responses capability of AI productivity tool enableable software applications or firmware for hardware components to execute this intent capability according to an embodiment of the present disclosure;

FIG. 3 is a block diagram illustrating an information handling system with computer readable code instructions for an OTB AI productivity tool and a machine learning model access coordination module for minimizing resource consumption by machine learning models to execute an identified user intent capability according to an embodiment of the present disclosure; and

FIG. 4 is a flow diagram illustrating a method for executing computer readable code instructions for an OTB AI productivity tool and computer readable code instructions for a machine learning model access coordination module to minimize resource consumption by machine learning models to achieve an identified user intent capabilities according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Traditionally, usage of machine learning models has involved gathering various values at an edge device, such as a user computing device information handling system, for input into a machine learning model located remotely from the information handling system, via a network. Recently, the artificial intelligence (AI) industry that includes machine learning model development has shifted toward storage of the machine learning models at the edge devices (e.g., user information handling system such as a laptop), in order to decrease network congestion and increase computation speed. The information handling system may be used to execute instructions of one or more artificial intelligence (AI) productivity tool enableable software applications, chat bots, or the like. Further, the information handling system may include an on the box (OTB) AI productivity tool employing machine learning models stored locally at the information handling system, as installed by a manufacturer of the information handling system, for optimizing user productivity and information handling system performance. The AI productivity tool employing one or more machine learning models may work in connection with query input software systems as well as capabilities of one or more AI productivity tool enablable software applications to provide responsive actions, functions, software services, or responses to user input queries. However, such local execution of these machine learning models consumes hardware resources also needed for execution of other local AI productivity tool enableable software applications to meet user experience expectations at the information handling system. A method is needed to balance these competing needs by minimizing hardware resource consumption of the machine learning models when executed locally at the information handling system.

The on the box (OTB) AI productivity tool in embodiments of the present disclosure may provide such a balance by automatically loading and unloading machine learning models in local random access memory (RAM) of an information handling system based on usage of those models by locally executing AI productivity tool enableable software applications. In embodiments herein, a manufacturer of edge devices, such as personal or enterprise laptops may develop and install on individual edge device information handling systems an OTB AI productivity tool that employs locally executed machine learning models to optimize user productivity and performance of the information handling system using artificial intelligence methodologies. Examples of such artificial intelligence methodologies to interface with one or more AI productivity tool enableable software applications includes chatbots to simulate conversations between the information handling system and the user to trigger changes in firmware (e.g., changing display or power settings) or processes of one or more AI productivity tool enableable software applications (e.g., send an e-mail or text message, schedule a meeting). Various machine learning models may be used to support such functionality in embodiments herein, including automatic speech recognition (ASR) models, text embedding models, and similarity search models that work in combination with one another to detect a user's intent within a received audio or text query input of the user. Other machine learning models may also be executed locally at the information handling system, separate and apart from chatbot functionality, such as models for battery optimization, battery swelling detection and avoidance, and smart system diagnostics, among other machine models directed at optimizing performance at the information handling systems, via an AI productivity tool enableable software application or firmware.

In each of these cases, the machine learning models must be loaded into RAM at the information handling system in order to receive input values, such as query inputs and to provide output of a query input intent value for correlating with capability intent values to use AI productivity tool enableable software applications or firmware at the information handling system to respond to a user query input. For example, in embodiments involving chatbots, each of the ASR models, text embedding models, and similarity search models must be loaded into RAM in order to provide an output, such as a detected user query intent vector value within a received user query input, or an identified and registered capability for an AI productivity tool enableable software application having a capability intent value that correlates to the query input intent value, indicating that execution of the capability by the AI productivity tool enable software application may address the user's intended request within the received user query input. In embodiments herein, a hardware processor executing machine-readable code instructions of a query intent to capability determination module of the OTB AI productivity tool may associate the detected user query intent vector value for “decrease power consumption” or “send a text message” with a capability intent vector value published, registered, or established for an AI productivity tool-enablable software application at the information handling system for executing capabilities, operations, software services or responses, such as placing a battery into power saving mode or composing and sending a text message via a text messaging software application.

Upon determination of a capability involving operations, software services or responses to be performed in response to the received user query input, as translated to a query intent value using the above described machine learning models, a hardware processor executing machine-readable code instructions of the OTB AI productivity tool may then direct the AI productivity tool enableable software applications executing at the information handling system to perform the identified corresponding published or registered capability. Thus, the machine learning model stored in RAM and executing at a local hardware processor, alone with the OTB AI productivity tool also executing at a local hardware processor, and local software applications may all simultaneously consume hardware resources such as CPU resources, other hardware processor resources (e.g., GPU, VPU), and RAM. Where some machine learning models are loaded into RAM but not actively used, this may have adverse effects on the information handling system and limit its operations for other functions.

The hardware processor executing machine-readable code instructions of a machine learning model access coordination module in embodiments may orchestrate the usage of machine learning models based on requests received by locally executing AI productivity tool enableable software applications. In embodiments, a hardware processor executing machine-readable code instructions of a machine learning model access coordination module may further remove any given machine learning model from RAM, to storage at a local solid state drive (SSD) memory device that consumes fewer hardware component resources (e.g., hardware processor resources, memory resources) than storage in RAM when it is determined that the machine learning model is no longer in an active state of use by any local AI productivity tool enableable software applications, or when hardware resource consumption meets a maximum allowable threshold value (e.g., 90% central processing unit (CPU) utilization, 90% RAM utilization). In such a way, the hardware processor executing machine-readable code instructions of a machine learning model access coordination module may balance competing needs for hardware resources by software applications and by machine learning models by automatically loading and unloading machine learning models in local RAM of an information handling system based on usage of those models by locally executing AI productivity tool enableable software applications. This may improve the function of the information handling system that operates an OTB AI productivity tool.

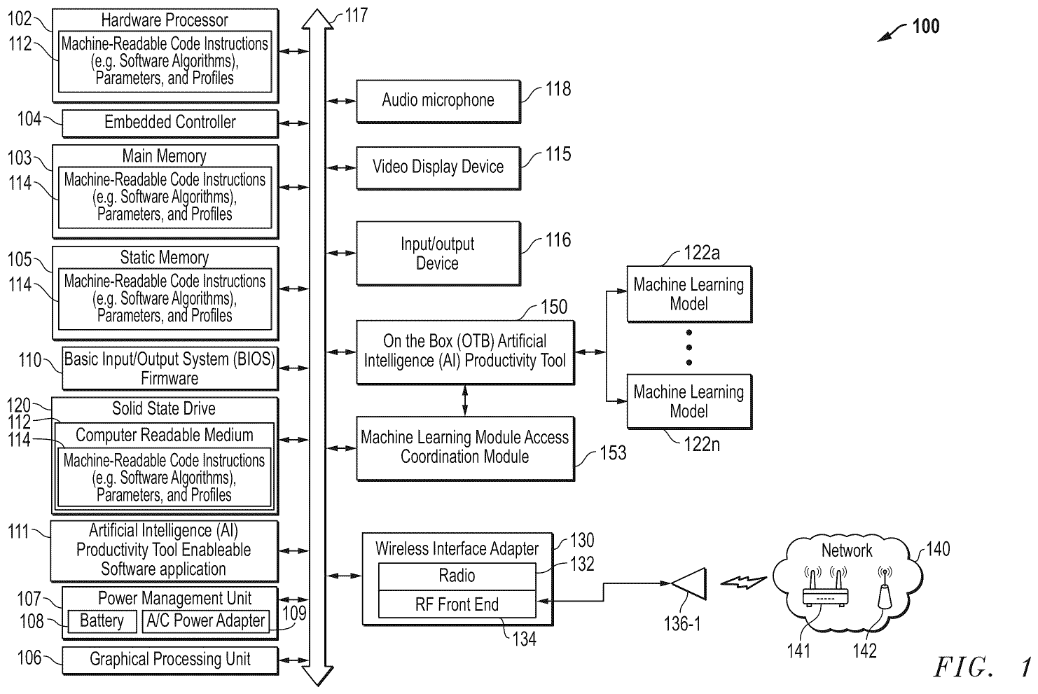

Turning now to the figures, FIG. 1 illustrates an information handling system 100 similar to the information handling systems according to several aspects of the present disclosure. As described herein, hardware processor 102 executing machine-readable code instructions of an on the box (OTB) artificial intelligence (AI) productivity tool 150 in an embodiment may balance resource consumption by locally executed machine learning models, such as 122a to 122n and by locally executed AI productivity tool enableable software applications 111. The hardware processor 102 executing machine-readable code instructions of a machine learning model access coordination module 153 may do so by automatically loading and unloading machine learning models 122a to 122n in local random access memory (RAM) of a main memory device 103 for an information handling system 100 based on usage state of those machine learning models 122a to 122n by locally executing AI productivity tool enableable software applications 111. In an embodiment, a manufacturer of edge devices, such as personal or enterprise laptops (e.g., information handling system 100) may develop and install on individual edge device information handling systems (e.g., 100) an machine readable code instructions of an OTB AI productivity tool 150 that employs locally executed machine learning models 122a to 122n to optimize user productivity and performance of the information handling system 100 using artificial intelligence methodologies for executing capabilities for responsive operations, software services, or text or audio responses.

Instances of the computer readable code instructions machine learning models 122a to 122n may be stored by the manufacturer, prior to use by an AI productivity tool enableable software application 111 within solid state drive (SSD) memory 120 in the form of one or more sets of machine-readable code instructions 114. An instance 114 of the machine learning models 122a to 122n must be loaded into main memory 103 RAM at the information handling system 100 in order to receive input values, such as user query input and to provide output for usage by code instructions 114 of the AI productivity tool enableable software applications 111 or firmware at the information handling system 100. The instance 114 of the machine learning models 122a to 122n stored in main memory 103 RAM and executing at a local hardware processor (e.g., 102 or 106), the code instructions 114 of the OTB AI productivity tool 150 also executing at a local hardware processor 102, and local AI productivity tool enableable software applications 111 may all simultaneously consume hardware resources such as processor 102 or 106 resources, and resources of various memory such as main memory 103 (e.g., hardware RAM) or drives for static memory, 105, or solid state or magnetic storage drives 120, for example.

A hardware processor 102 executing machine-readable code instructions of a machine learning model access coordination module 153 in an embodiment orchestrates the usage of machine learning models 122a to 122n based on requests received by locally executing AI productivity tool enableable software applications 111. In embodiments, the hardware processor 102 executing machine-readable code instructions of a machine learning model access coordination module 153 may further remove any given machine learning model, such as 122a from main memory 103 RAM, when underutilized for storage at a local solid state drive (SSD) memory device 120 such that it consumes fewer hardware component resources (e.g., hardware processor 102 or GPU 106 resources, and memory 103 resources) than storage in main memory 103 RAM. Removal of a machine learning module from main memory 103 RAM occurs when the hardware processor 102 executing machine-readable code instructions of a machine learning model access coordination module 153 determines that the machine learning model 122a is no longer in active use by any local AI productivity tool enableable software applications 111, or when the hardware processor 102 executing machine-readable code instructions of a machine learning model access coordination module 153 determines that hardware resource consumption meets a maximum allowable threshold value (e.g., 90% central processing unit (CPU) utilization, 90% RAM utilization). In such a way, the hardware processor 102 executing machine-readable code instructions of a machine learning model access coordination module 153 in an embodiment may balance competing needs for hardware resources by AI productivity tool enableable software applications 111 and by machine learning models 122a to 122n by automatically loading and unloading machine learning models 122a to 122n in local main memory 103 RAM of an information handling system 100 based on usage state determined for those machine learning models 122a to 122n by locally executing AI productivity tool enableable software applications 111.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, other hardware controllers, or any combination thereof. Additional components of the information handling system 100 may include one or more storage devices such as static memory 105 or drive unit 120. The information handling system 100 may include or interface with one or more communications ports for communicating with external devices, as well as an input/output (IO) device 116, a video/graphics display device 115, an audio microphone 118 for recording user communications, or any combination thereof. Portions of an information handling system 100 may themselves be considered information handling systems 100.

Information handling system 100 may include devices or modules that embody one or more of the hardware devices or hardware processing resources executing machine readable code instructions for one or more software or firmware systems and modules. The information handling system 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood any or all portions of machine readable code instructions (e.g., software or firmware algorithms), parameters, and profiles 114 may operate on a plurality of information handling systems 100. In a specific embodiment, code instructions for the OTB AI productivity tool 150, the machine learning model access coordination module 153, for the machine learning models 122a to 122n, and one or more AI productivity tool enableable software applications 111 may execute locally at the information handling system 100, or on the box.

The information handling system 100 may include the hardware processor 102 such as a central processing unit (CPU) or other hardware processing resources. Any of the hardware processing resources may operate to execute machine readable code instructions 114 that are either firmware or software code. Moreover, the information handling system 100 may include memory such as main memory 103, static memory 105, and disk drive unit 120 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, EC 104, GPU 106, or any other hardware processing device. The information handling system 100 may also include one or more buses 117 operable to transmit communications between the various hardware components such as any combination of various I/O devices 116 as well as between hardware processors 102, an EC 104, GPU 106 or other, the operating system (OS) 111, the basic input/output system (BIOS) 110, the wireless interface adapter 130, or a radio module 132, among other components described herein. In an embodiment, the hardware processor 102, EC 104, and/or GPU 106 may execute one or more bus drivers in order to transmit this data between the information handling system 100 and the input/output devices 116 described herein. As described herein, the information handling system 100 further includes a video/graphics display device 115. The video/graphics display device 115 in an embodiment may function as a liquid crystal display (LCD), an organic light emitting diode (OLED), a flat panel display, or a solid-state display. It is appreciated that the video/graphics display device 115 may be wired or wireless and may be an external video/graphics display device 115 that allows a user to increase the desktop area by extending the desktop in an embodiment.

A network interface device of the information handling system 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the network 140, via, for example, a Bluetooth® or Bluetooth® Low Energy (BLE) protocols, or other WPAN or WLAN protocols.

In an embodiment, a WAN, WWAN, LAN, and WLAN may each include an AP 141 or base station 142 used to operatively couple the information handling system 100 to a network 140 via a wireless interface adapter 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system 100. Wireless interface adapter 130 may include one or more RF (RF) subsystems (e.g., radio 132) with transmitter/receiver circuitry, modem circuitry, one or more antenna RF (RF) front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHZ)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHZ, or 6 GHz bands which may be shared communication frequency bands with WWAN protocols or Bluetooth® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, hardware processor or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable code instructions, parameters, and profiles 114 or receives and executes instructions, parameters, and profiles 114 responsive to a propagated signal, so that a hardware device connected to a network 140 may communicate voice, video, or data over the network 140. Further, the machine readable code instructions 114 may be transmitted or received over the network 140 via the network interface device or wireless interface adapter 130.

The information handling system 100 may include a set of instructions 114 that may be executed to cause the computer system to perform any one or more of the methods or computer-based functions disclosed herein. For example, machine readable code instructions 114 may be executed by a hardware processor 102, GPU 106, EC 104 or any other hardware processing resource and may include software agents, or other aspects or components used to execute the methods and systems described herein. Various software modules comprising application machine readable code instructions 114 may be coordinated by an OS 111, and/or via an application programming interface (API) include a unified device API described herein. An example OS 111 may include Windows®, Android®, and other OS types. Example APIs may include Win 32, Core Java API, or Android APIs.

In an embodiment, the information handling system 100 may include a disk drive unit 120. The disk drive unit 120 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC 104, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 120 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 120 during execution by the hardware processor 102, EC 104, or GPU 106 of information handling system 100.

Main memory 103 or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 120 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 107 (a.k.a. a power supply unit (PSU)). The PMU 107 may include a hardware controller and executable machine-readable code instructions to manage the power provided to the components of the information handling system 100 such as the hardware processor 102 and other hardware components described herein. The PMU 107 may control power to one or more components including the one or more drive units 120, the hardware processor 102 (e.g., CPU), the EC 104, the GPU 106, a video/graphic display device 115, or other wired I/O devices 116 and other components that may require power when a power button has been actuated by a user. In an embodiment, the PMU 107 may monitor power levels and be electrically coupled to the information handling system 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 105 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

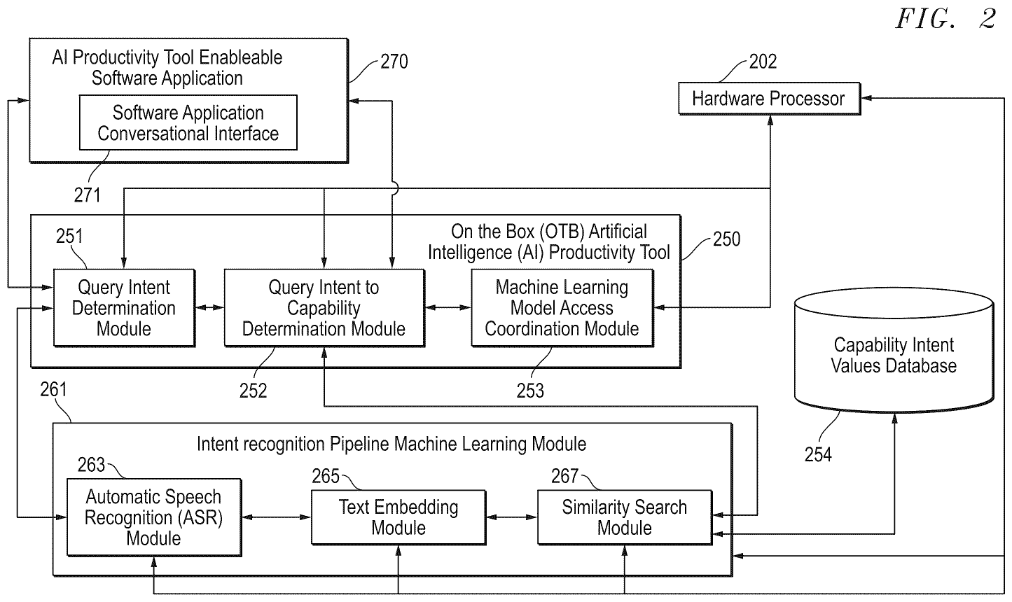

FIG. 2 is a block diagram illustrating an on the box (OTB) artificial intelligence (AI) productivity tool with a machine learning model access coordination module for orchestrating a plurality of machine learning modules to match a determined query intent value for a user's query input to a registered capability intent value for an AI productivity tool-enablable software application according to an embodiment of the present disclosure. The AI productivity tool enableable software application in an embodiment may then execute a responsive capability for operations, software services, or generating a response to meet the chatbot input query. As described herein, local execution of the machine learning models by AI productivity tool enableable software applications 270 at edge devices, such as end user information handling systems consumes hardware resources also needed for execution of other local software applications at that information handling system to meet user experience expectations at the information handling system. A hardware processor 202 executing machine-readable code instructions of a machine learning model access coordination module 253 of the OTB) AI productivity tool 250 in an embodiment may balance these competing needs by automatically loading and unloading machine learning models used by various machine learning modules (e.g., 263, 265, and 267) in local random access memory (RAM) of an information handling system based on usage of those models by locally executing AI productivity tool enableable software applications 270.

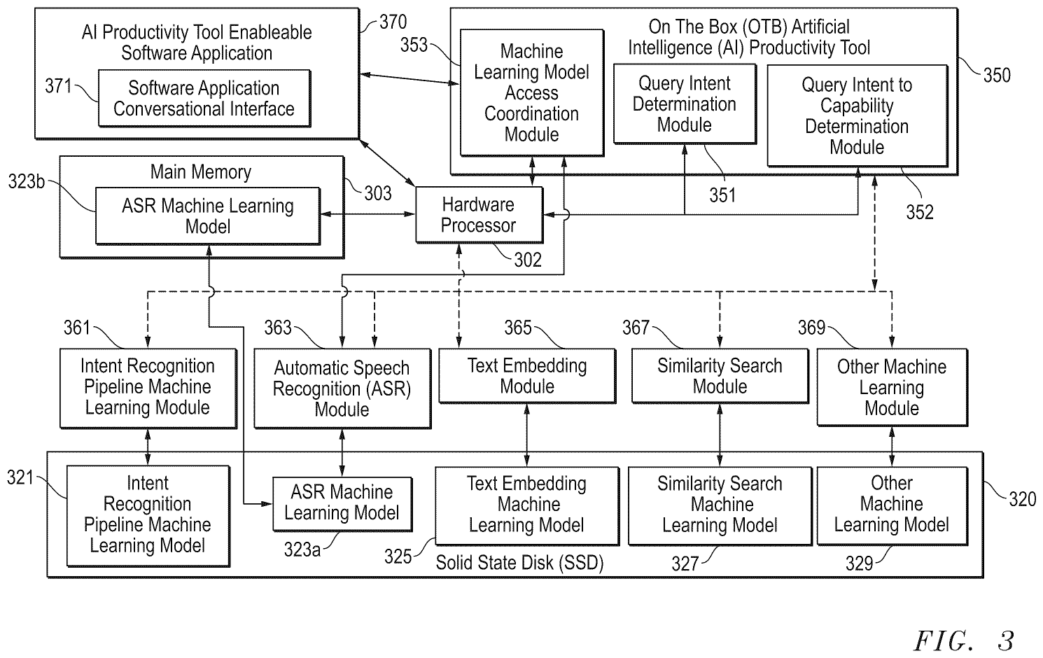

A manufacturer of edge devices, such as personal or enterprise computers may develop and install on individual edge device information handling systems machine readable code instructions for an OTB AI productivity tool 250 that employs one or more locally executed machine learning models, as driven by various machine learning modules, such as 263, 265, or 267 to optimize user productivity and performance of the information handling system using artificial intelligence methodologies. In an embodiment, the OTB AI productivity tool 250 may include a machine learning model access coordination module 253 to, when prompted via the AI productivity tool enablable software application 270, load a specific machine learning model, as described in greater detail below with respect to FIG. 3. During operation for example, the hardware processor 202 executing machine-readable code instructions of the machine learning model access coordination module 253 may load one or more machine learning models such that, for example, the text or voice input from the user may be processed through a speech recognition models and/or processed through any of a plurality of natural language models or other ML models in order to determine a text of a user's input query or an intent value of the user's input query.

Examples of artificial intelligence methodologies includes ML model algorithms used with chatbots, such as software application conversation interface 271 to simulate conversations between the information handling system executing machine readable code instructions of the AI productivity tool enableable software application 270 and the user, via the OTB AI productivity tool 250 to execute one or more capabilities for an application software service, response or other function in response to a user query input. For example, a response to a user query via OTB AI productivity tool 250 may trigger processes of one or more AI productivity tool enableable software applications (e.g., 270) in embodiments herein. A hardware processor 202 executing machine-readable code instructions for various machine learning modules (e.g., 263, 265, and 267) may implement the use of such machine learning models from memory to support such functionality in an embodiment. For example, an automatic speech recognition (ASR) module 263, a text embedding module 265, or a similarity search module 267 that work in various combinations with one another to detect a user's audio speech input, conversion to text or detecting text, and detecting an intent, represented by an intent vector value, within user query input received from the software application conversation interface 271. Further, the hardware processor 202 executing machine-readable code instructions of an intent recognition pipeline machine learning module 261 may orchestrate the interplay between each of the ASR module 263, text embedding module 265, and similarity search module 267 to establish a query intent vector value in a multi-axis vector space defined with these machine learning models an correlate that query intent value with a corresponding capability intent value in an embodiment.

In an example embodiment, a user may provide a user query input in the form of text or voice data (e.g., via IO device 116, or microphone 118 of FIG. 1) to a software application conversation interface 271, executing machine readable code instructions as a chatbot with the OTB AI productivity tool 250 to simulate a conversation between the user and the AI productivity tool enableable software application 270. The AI productivity tool enableable software application 270 in an embodiment operates with the OTB AI productivity tool 250 for optimizing performance of the information handling system (e.g., directed at optimizing performance of hardware components or other software applications at the information handling system), or may be one of several software applications routinely executing on the information handling system, as optimized by received user query input at such a OTB AI productivity tool 250. In each of these scenarios, AI productivity tool enableable software application 270 may have or publish a list of recognized “capabilities” or functionalities that it may perform during execution of such an AI productivity tool enableable software application 270 in response to a query input received and processed by the OTB AI productivity tool 250 into a query intent vector value. The capabilities are provided text descriptors that may be processed into capability intent values in the multi-axis vector space such that these intent value mathematical representations of a query and a capability may be correlated by a similarity matching algorithm to select a capability responsive to an input query from a user.

In an embodiment, a capability intent values database 254 may store a plurality of capabilities associated with each of a plurality of AI productivity tool-enablable software applications, such as 270. These capabilities stored at the capability intent values database 254 may include any input and output capabilities provided by the AI productivity tool-enablable software applications 270 being executed by the hardware processor 202 or any other hardware processing devices (104 or 106 of FIG. 1). For example, an AI productivity tool-enablable software application 270 may include a word processing application such as Microsoft® Word® that may receive input (e.g., via voice at a microphone 118 or text via a keyboard 116 of FIG. 1) and provide output via text. Still further, other examples of an AI productivity tool-enablable software application 270 may include an updating software, virus protection software, and setting optimization software such as Dell® SupportAssist® module executable by the hardware processor or other hardware processing resource of the information handling system. With SupportAssist® a user may provide input via, for example, the microphone (118 of FIG. 1) requesting information related to a setting associated with the information handling system. Thus, capabilities of SupportAssist® may include virus protection capabilities, setting manipulation capabilities, and software updating capabilities that may each be stored at the capability intent values database 254.

Even further, examples of an AI productivity tool-enablable software application 270 may include Dell® Display®/Peripheral Manager®. The Dell® Display®/Peripheral Manager® may have capabilities that include optimization of screen resolution, refresh rates, and gamma correction as well as webcam settings, mouse settings, keyboard settings, stylus settings, microphone settings, and trackpad settings, among other settings and connections associated with the wired or wireless input/output devices. Again, these capabilities associated with the execution of the Dell® Display®/Peripheral Manager® software may have capability intent values and a capability identifier stored at the capability intent values database 254 as described herein. It is appreciated that the AI productivity tool-enablable software application 270 may include, for example, Dell® Trusted Device® software, a remediation Dell® APEX Managed Device Service (AMDS)® software, Alienware Command Center (AWCC)® software, among others. Some AI productivity tool-enablable software applications 270 may even be subagents operating locally on the box of the information handling system but have remote access to a larger software application executing at a cloud based server location for providing software services in some embodiments herein.

These “capabilities” may be registered with the OTB AI productivity tool 250 in an embodiment for establishing intent values for these capabilities such that chat user query input intent values may be correlated with one or more capability intent values for registered capabilities, as described herein. For example, in an embodiment in which the AI productivity tool enableable software application 270 is software application for optimizing performance of hardware components at the information handling system, such capabilities may include adjusting settings or configurations for various hardware components, such as display device 215 via firmware 215a. As another example, in an embodiment in which the AI productivity tool enableable software application 270 optimizes performance of other software applications, such capabilities may include automatically downloading and installing updates for such AI productivity tool enableable software applications 270. In yet another example, in an embodiment in which the AI productivity tool enableable software application 270 is one of several software applications routinely executing on the information handling system, and optimized by such an OTB AI productivity tool 250, such capabilities may include automatically generating and transmitting e-mails or text messages, automatically scheduling meetings, or generating chatbot or other user interface responses. These “capabilities” may be registered, associated with a specific AI productivity tool enableable software application 270, and stored at the capability intent values database 254 in an embodiment.

Each of the capabilities stored at the capability intent values database 254 may have a description with text descriptors, may be associated with a unique ID, and may have a capability intent value in an embodiment. Upon registration of a given capability by the AI productivity tool enableable software application 270 in an embodiment, a hardware processor 202 for the information handling system may execute machine readable code instructions for one or more text embedding algorithms to generate a multi-dimensional vector capability intent value for that capability that, for example, may be based on text descriptors for that capability. Each of these capability intent values for association with these capabilities may also be associated with an ID such as an alphanumeric ID that may identify, uniquely, these capabilities in the capability intent values database 254, for example. These capability intent values may later be used to determine which of the capabilities a user intends to invoke or execute within a received user query input based on similarity with a query intent value, as described herein.

When a user provides a user query input in the form of text or voice data (e.g., via IO device 116, or microphone 118 of FIG. 1) to the software application conversation interface 271, the hardware processor 202 executing machine-readable code instructions of the OTB AI productivity tool 250 in an embodiment may orchestrate determination of the user's intended goals within the user query input (e.g., what the user wishes to achieve with this communication) with determination of a query input intent value, identify one or more capabilities associated with the AI productivity tool enableable software application 270 having a correlating capability intent value and thus, capable of executing a response to this user query input intent, and initiate performance of one or more tasks employing those capabilities to achieve the user-intended results to the user query input. This orchestration in an embodiment may begin with the hardware processor 202 executing machine-readable code instructions of the query intent determination module 251 to receive the user query input via microphone, image, or text input, and initiate execution of machine readable code instructions for an intent recognition pipeline machine learning module 261. In an embodiment, the hardware processor 202 executing machine-readable code instructions for the intent recognition pipeline machine learning module 261 may further orchestrate any combination of a plurality of machine learning modules (e.g., 363, 365, or 367) to determine the user's intended goal or query intent within the received text or voice data of the user query input.

This may cause the hardware processor 202 executing machine-readable code instructions of a machine learning model access coordination module 253 to invoke one or more machine learning models. During operation for example, the hardware processor 202 executing machine-readable code instructions of the machine learning model access coordination module 253 may load one or more machine learning models into RAM such that, for example, the voice audio user query input may be processed through a speech recognition model, such as with ASR module 263, to be recognized text, and text embedding module 265 to determine a query intent value of the user's query input from text of the query input. This chatbot query input intent value may then be matched or correlated to a closest capability intent value stored in the capability intent values database 254 for published capabilities via a similarity search module 267 to find an AI productivity tool-enablable software applications 270 to execute a responsive capability for operations, software services, or generating a response to meet the chatbot input query. These software modules 263, 265, and 267 include ML model algorithms for conducting the described operations.

For example, in an embodiment in which the user provides a user query input in the form of voice data to the AI productivity tool enableable software application 270 via the OTB AI productivity tool 250 and the software application conversation interface 271, the hardware processor 202 executing machine-readable code instructions of the intent recognition pipeline machine learning module 261 may orchestrate consecutive executions, via the hardware processor 202, of machine-readable code instructions of an automated speech recognition (ASR) module 263 to detect words within the recorded voice data and determine a text representation of the detected words in speech, a text embedding module 265 to detect which of these words are nouns, verbs, or commonly used sentence structures and generate a vectorized query input intent value for the user query input, and a similarity search module 267 to compare the vectorized query input intent value with the capability intent values stored within the capability intent value database 254. This comparison may include execution of one or more of the machine learning models, as described in FIG. 3 below, to determine one or more previously registered capabilities for the AI productivity tool enableable software application 270 having similar wording and sentence structure as the detected words and identified sentence structures output by execution of code instructions of the text embedding module 265 by the hardware processor 202 for the received user query input. Such a comparison, in an embodiment, may include, for example, determining when a distance or value difference between the vectorized query input intent value and the vectorized capability intent value falls below a threshold maximum value to meet a similarity correlation requirement and determine responsiveness of the capability.

In an embodiment in which the user provides text data to the AI productivity tool enableable software application 270, such an intent recognition pipeline machine learning module 261 may truncate this process to exclude processes of the ASR module 263. The hardware processor 202 executing machine-readable code instructions of the intent recognition pipeline machine learning module 261 in an embodiment may apply the text embedding module 265 to generate a query intent value as described and then return the output query intent value of the text embedding module 265 to the query intent to capability determination module 252. The query intent to capability module may utilize the similarity search module 267 for a correlation between the query intent value received and a stored capability intent value and identify a capability as meeting a correlation threshold. This output from the query intent to capability determination module 252 in an embodiment may take the form of one or more identified capability intent IDs that specifically identify a capability of the AI productivity tool enableable software application 270 having a vectorized capability intent value that falls within a tolerated maximum distance or value difference of the query input intent value, for example. As described herein and specifically in greater detail below with respect to FIG. 3, each of these machine learning modules 261, 263, 265, and 267 may utilize one or more machine learning models as stored in RAM and executed by a local hardware processor at the information handling system that is also executing the AI productivity tool enableable software application 270 and other software applications.

For example, the detected intent having a query intent value in a multi-axis vector space, such as “decrease display brightness,” “speed up my application,” or “send a text message” may be associated with a known capability or functionality of AI productivity tool enableable software application 270 at the information handling system. More specifically, the intent “decrease display brightness” may be associated with a capability for adjusting settings or configurations for a display device (115 of FIG. 1), based on similarity correlation between a query intent value and a capability intent value as determined by the similarity search module 267. As another example, the query intent “speed up my application” may be associated with a capability associated with the AI productivity tool enableable software application 270 for automatically downloading and installing updates for such AI productivity tool enableable software application 270, based on similarity correlation between a query intent value and a capability intent value as determined by the similarity search module 267. In yet another example, the query intent “send a text message” may be associated with a capability of the AI productivity tool enableable software application 270 to automatically generate and transmit text messages, based on similarity correlation between a query intent value and a capability intent value as determined by the similarity search module 267. As described above, these “capabilities” may be registered and associated with a specific AI productivity tool enableable software application 270 at the capability intent value database 254 in an embodiment.

Upon identification of a capability that addresses the determined query “intent” of the user within the received user query input, the hardware processor 202 executing machine-readable code instructions of the OTB AI productivity tool 250 may direct execution of one or more processes at the AI productivity tool enableable software application 270, via the software application conversational interface 271 associated with that capability. For example, the hardware processor 202 executing machine-readable code instructions of the query intent to capability determination module 252 may directly instruct the AI productivity tool enableable software application 270 to undertake the identified “capability.”. In such a way, the OTB AI productivity tool 250 may orchestrate a plurality of machine learning modules via an intent recognition pipeline machine learning module 261 to determine a query intent from a received user query input, and identify a corresponding vectorized capability intent value having threshold similar to the query intent value and execute a capability of the AI productivity tool enableable software application 270 to execute this capability as an operation, software service, response, or other function responsive to the user's query input.

FIG. 3 is a block diagram illustrating an on the box (OTB) artificial intelligence (AI) productivity tool for minimizing hardware component resource consumption during local execution of machine learning models to achieve an identified user intent according to an embodiment of the present disclosure. As described herein, a manufacturer of edge devices, such as personal or enterprise computers may develop and install on individual edge device information handling systems an OTB AI productivity tool 350 that employs locally executed machine learning models (e.g., 323b) to optimize user productivity and performance of the information handling system using artificial intelligence methodologies. Examples of such artificial intelligence methodologies includes chatbots, such as software application conversational interface 371 to simulate conversations between the information handling system and the user to trigger processes of one or more AI productivity tool enableable software applications 370 (e.g., send an e-mail or text message, schedule a meeting). Various machine learning models may be used to support such functionality in embodiments herein, including automatic speech recognition (ASR) model 323a or 323b, text embedding model 325, and similarity search model 327 that work in combination with one another, under the direction of the intent detection pipeline machine learning model 321 to detect a user's intent within a received user query input in the form of an audio or text recording of the user. Other machine learning models 329 may also be executed locally at the information handling system, separate and apart from chatbot functionality, such as models for battery optimization, battery swelling detection and avoidance, and smart system diagnostics, among other machine models directed at optimizing performance at the information handling systems.

In each of these cases, the machine learning models (e.g., 321, 323a, 323b, 325, 327, or 329) must be loaded into random access memory (RAM) in main memory 303 at the information handling system in order to receive input values and to provide output for usage by AI productivity tool enableable software applications 370 at the information handling system. For example, in embodiments involving chatbots, each of the ASR model 323a, text embedding model 325, and similarity search model 327 must be loaded into RAM in main memory 303 in order to provide an output, such as an identified and previously registered capability for an AI productivity tool enableable software application 370 that addresses a detected user intent within a received user query input In a specific embodiment shown with respect to FIG. 3, an instance 323b of the ASR machine learning model 323a may be stored in RAM at main memory 303. This is only one example of a machine learning model being loaded into RAM at main memory 303. In other embodiments, an instance of any of the other machine learning models 321, 325, 327 or 329 may also be loaded into RAM according to embodiments herein.

The hardware processor 302 executing machine readable code instructions of the machine learning model access coordination module 353 of the OTB AI productivity tool 350 in an embodiment may orchestrate the usage of machine learning models, such as 321, 323a, 325, 327, or 329 based on requests received by locally executing AI productivity tool enableable software applications, such as 370. In an embodiment, the hardware processor 302 executing machine readable code instructions of the machine learning model access coordination module 353 may further remove any given instance of a machine learning model, such as 353b from RAM in main memory 303. Another instance of such a machine learning model removed from RAM in main memory 303 may remain in storage at a local solid state drive (SSD) memory device 320 that consumes fewer hardware component resources (e.g., hardware processor 302 resources, memory 303 resources) than storage in RAM. The hardware processor 302 executing machine readable code instructions of the machine learning model access coordination module 353 may perform such a removal from RAM in main memory 303 when it is determined through the hardware processor 302 executing machine readable code instructions of the machine learning model access coordination module 353 that the instance of the machine learning model (e.g., 323b) is no longer in use by any local AI productivity tool enableable software application, such as 370, or when hardware resource consumption meets a maximum allowable threshold value (e.g., 90% utilization of hardware processor 302, 90% utilization of main memory 303).

Each of a plurality of machine learning models (e.g., 321, 323a, 325, 327, or 329) in an embodiment may be stored in cold storage, such as on a solid state drive (SSD) 320 for the information handling system, when the machine learning model (e.g., 321, 323a, 325, 327, or 329) is not being accessed or receiving input from an AI productivity tool enableable software application (e.g., 370). Storage in SSD 320 in an embodiment may consume fewer hardware component resources, such as hardware processor 302 resources or main memory 303 resources. In addition, storage in SSD 320 in an embodiment may consume less power than storage in RAM main memory 303.

In an embodiment, a hardware processor 302, such as a central processing unit (CPU) may execute code instructions of a first AI productivity tool enableable software application 370 to request permission from the machine learning model access coordination module 353 for a specific hardware processor, such as hardware processor 302 or another available hardware processor (e.g., 104 or 106 in FIG. 1), to input values into an instance of a specific machine learning model (e.g., 321, 323a, 325, 327, or 329). Thus, the hardware processor 302 identified within FIG. 3 may be any of a plurality of hardware processors such as a CPU, GPU, or VPU for executing the instances of the machine learning models 321, 323a, 325, 327, or 329, and may be the same or different from the hardware processor executing code instructions of the AI productivity tool enableable software application 370.

In a specific example, hardware processor 302 executing machine readable code instructions of the AI productivity tool enableable software application 370 may receive of a user query input in the form of a user's voice or text communication via the software application conversational interface 371, and request permission from the machine learning model access coordination module 353 for the hardware processor 302 (e.g., CPU, GPU, or VPU) to input values into the ASR model 323a via the ASR module 363. This is only one example of a request for access to a machine learning model and it is contemplated that any stored machine learning model may be requested by the AI productivity tool enableable software application 370 in such a way. As described above with respect to FIG. 2, this may be the first step orchestrated by hardware processor 302 executing machine readable code instructions of the machine learning model access coordination module 353 to orchestrate determination via the query intent to capability determination module 352 of a user's intent to enact a function of the AI productivity tool enableable software application 370.

A hardware processor 302 executing machine readable code instructions of the machine learning model access coordination module 353 in an embodiment may load an instance 323b of the requested machine learning model (e.g., 323a) into random access memory (RAM), such as within main memory 303. As described herein, machine learning models may only receive input from a given AI productivity tool enableable software application 370 when loaded or stored within RAM of main memory 303. In other example embodiments, the hardware processor 302 executing machine readable code instructions of the machine learning model access coordination module 353 may load an instance of the intent recognition pipeline machine learning model 321 into main memory 303, an instance of the text embedding machine learning model 365 into main memory 303, an instance of the similarity search machine learning model 367 into main memory 303, or instances of machine learning models 329 directed at optimizing performance at the information handling system, for example, into main memory 303.

Each machine learning model (e.g., 321, 323a, 325, 327, 329) may comprise, for example, weight matrices for a multilayered neural network for predicting likely outputs for received input values based on learned behavioral models. More specifically, the ASR machine learning model 323a may include weight matrices for a multilayered neural network for detecting words within a user query input in the form of recorded voice data received from the AI productivity tool enableable software application 370. As another example, a text embedding machine learning model 325 may include weight matrices for a multilayered neural network for detecting which of these words (such as text output by the ASR machine learning model 323a) are nouns, verbs, or commonly used sentence structures, and to assign vector values (e.g., in a multi-axis vector space) to each user query input for comparison to vector values of previously stored capability intent vector values. In another example, the similarity search machine learning model 327 may include weight matrices for a multilayered neural network for determining a stored capability intent vector having a value that is closest to the determined user query input value to identify a registered capability of the AI productivity tool enableable software application 370 to address the user's intended request within the received user query input.

The hardware processor 302 executing machine readable code instructions of the machine learning model access coordination module 353 in an embodiment may allow the requested hardware processor (e.g., hardware processor 302) identified in the request for access to the machine learning model (e.g., 323a) received from the AI productivity tool enableable software application 370 exclusive access to input values into the instance 323b of the machine learning model (e.g., 323a) that is now loaded into RAM in main memory 303. Multiple software applications (e.g., including 370) may access a plurality of machine learning models (e.g., 321, 323a, 325, 327, or 329), via a plurality of hardware processors, including 302. In order to ensure that each instance of a given machine learning model (e.g., 323b) is accessed by only one hardware processor (e.g., 302) executing code instructions for a single AI productivity tool enableable software application 370 at any given time, the hardware processor 302 executing machine readable code instructions of the machine learning model access coordination module 353 in an embodiment may orchestrate which hardware processors (e.g., 302) have access to a specific instance (e.g., 323b) of a machine learning model (e.g., ASR machine learning model 323a) that has been loaded into RAM of the main memory 303 at any given time. In other words, the hardware processor 302 executing machine readable code instructions of the machine learning model access coordination module 353 in an embodiment may issue a “ticket” allowing access to a currently loaded instance 323b of a machine learning model 323a within RAM of main memory 303 exclusively to the hardware processor 302 while executing code instructions of the AI productivity tool enableable software application 370.

Upon issuance of such a “ticket,” the hardware processor 302 may execute code instructions of the AI productivity tool enableable software application 370 to input values (e.g., a recorded audio file or text file received from the software application conversational interface 371) into the instance of a machine learning model such as 323b of the ASR machine learning model 323a that has been loaded into RAM in the main memory 303. As described in greater detail above with respect to an example embodiment of FIG. 2, the output from the instance 323b of the ASR machine learning model 323a may then be fed through the text embedding module 365, and the similarity search module 365 to identify a capability of the AI productivity tool enableable software application 370 for addressing the intended request by the user within the received user query input. Use of each of these modules 365 and 367 in an embodiment may further trigger loading of their respective instances machine learning models 325 and 327 into RAM of the main memory 303, consecutively or they may be already-maintained in RAM in main memory 303 servicing a hardware processor 302 from previous usages. The above-described example applies to RAM occupancy of multiple instances of machine learning models from plural machine learning modules executing or executable at an information handling system may be tracked according to embodiments herein based on loading of the same into main memory by execution of AI productivity tool-enableable software applications 370 or the like.

In an embodiment, the hardware processor 302 executing machine readable code instructions of the machine learning model access coordination module 353 may determine whether input is currently being input into a currently loaded instance (e.g., 323b) of the machine learning model (e.g., ASR machine learning model 323a) reserved for access via the hardware processor (e.g., 302) assigned to provide such input. For example, upon output by the loaded instance 323b of the ASR machine learning model 323a of recognized speech within the recorded audio or text file input into the loaded machine learning model instance 323b, the hardware processor 302 may cease to input further values into the machine learning model instance 323b. The hardware processor 302 executing machine readable code instructions of the machine learning model access coordination module 353 in an embodiment may monitor such activity of the hardware processor currently assigned to usage of the loaded instance 323 of the machine learning model 323a, and can detect when such input has ceased. In some embodiments, code instructions of the first AI productivity tool enableable software application 370 may execute, via the hardware processor 302 to affirmatively notify the machine learning model access coordination module 353 that the first AI productivity tool enableable software application 370 no longer needs access to the requested instance 323b of the machine learning model 323a, thus essentially releasing the assigned “ticket.”

In an embodiment in which the hardware processor 302 executing machine readable code instructions of the machine learning model access coordination module 353 determines that input is not currently being input into the instance 323b of the ASR machine learning model 323a, or that the first AI productivity tool enableable software application 370 no longer needs access to the requested instance 323b of the ASR machine learning model 323a, the hardware processor 302 executing machine readable code instructions of the machine learning model access coordination module 353 may execute to start a machine learning model unloading countdown timer. Loading an instance of any given machine learning model (e.g., 321, 323a, 325, 327, or 329) into RAM of main memory 303 in an embodiment may require processing time and cause latency, for example up to eight seconds of processing time in some examples. Thus, it is preferable to retain an instance of a machine learning model (e.g., 321, 323a, 325, 327, or 329) that is likely to be used imminently. However, storage of an instance of a machine learning model (e.g., 321, 323a, 325, 327, or 329) within RAM of main memory 303 also consumes hardware component resources (e.g., hardware processor 302 or main memory 303 resources) at a higher rate than storage in SSD 320, and this RAM occupancy may negatively impact user experience or functionality of concurrently processing software applications. As such, prior to removal of the instance 323b of the ASR machine learning model 323a from RAM in main memory 303, the hardware processor 302 executing machine readable code instructions of the machine learning model access coordination module 353 may start a machine learning model unloading countdown timer to gauge whether the hardware processor 302 executing machine readable code instructions of the AI productivity tool enableable software application 370 or any other software application requests access to the instance 323b of the ASR machine learning model 323a within a short time period after the hardware processor 302 executing machine readable code instructions of the AI productivity tool enableable software application 370 ceases inputting values into the instance 323b. Such a machine learning model unloading countdown timer in an embodiment may be, for example, seconds, or one, five, ten, or fifteen minutes, and may be adjustable by the user in various embodiments. In an embodiment in which the hardware processor 302 executing machine readable code instructions of the machine learning model access coordination module 353 has determined that input is still not currently being received at the instance 323b of the ASR machine learning model 323a after the machine learning model unloading countdown timer has elapsed, the hardware processor 302 executing machine readable code instructions of the machine learning model access coordination module 353 may remove the instance 323b from RAM in main memory 303.

As another way of conserving hardware component consumption rates due to RAM occupancy for storage of instances (e.g., 323b) of machine learning models (e.g., 323a) within RAM of the main memory 303, the hardware processor 302 executing machine readable code instructions of the machine learning model access coordination module 353 may also monitor utilization rates for one or more hardware components during running of the machine learning model unloading countdown timer. For example, if, prior to expiration of the machine learning model unloading countdown timer, the hardware processor 302 executing machine readable code instructions of the machine learning model access coordination module 353 in an embodiment determines that utilization rates for one or more hardware components (e.g., hardware processor 302 or main memory 303) have reached a maximum threshold value (e.g., 90%), the hardware processor 302 executing machine readable code instructions of the machine learning model access coordination module 353 may remove the instance 323b from RAM in main memory 303 without waiting for expiration of the machine learning model unloading countdown timer. In such a way, the hardware processor 302 executing machine readable code instructions of the machine learning model access coordination module 353 may balance competing needs for hardware resources (e.g., hardware processor 302 and main memory 303) by AI productivity tool enableable software applications 370 and by machine learning model instances (e.g., 323b) by automatically loading and unloading instances (e.g., 323b) of machine learning models (e.g., 323a) in local RAM main memory 303 of an information handling system based on usage of those models by locally executing software applications, such as 370.

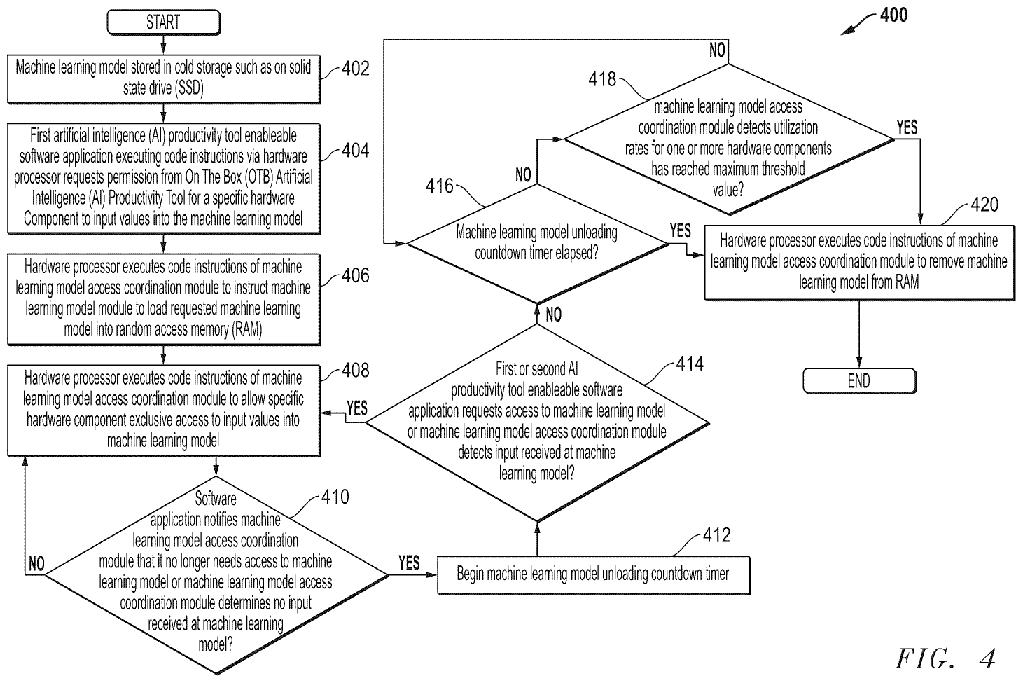

FIG. 4 is a flow diagram illustrating a method of an on the box (OTB) artificial intelligence (AI) productivity tool for minimizing hardware component resource consumption during local execution of machine learning models to achieve an identified user intent within a received user query input according to an embodiment of the present disclosure. As described herein, machine learning models stored in RAM and executing at a local hardware processor, the OTB AI productivity tool also executing at a local hardware processor, and local software applications may all simultaneously consume hardware resources such as CPU resources, other hardware processor resources (e.g., GPU, VPU), and RAM. The hardware processor executing machine readable code instructions of the machine learning model access coordination module in an embodiment may remove any given machine learning model from RAM, for storage at a local solid state drive (SSD) memory device that consumes fewer hardware component resources (e.g., hardware processor resources, memory resources) than storage in RAM when the hardware processor executing machine readable code instructions of the machine learning model access coordination module determines that the machine learning model is no longer in use by any local AI productivity tool enableable software applications, or when hardware resource consumption meets a maximum allowable threshold value (e.g., 90% central processing unit (CPU) utilization, 90% RAM utilization). In such a way, the hardware processor executing machine readable code instructions of the machine learning model access coordination module may balance competing needs for hardware resources by software applications and by machine learning models by automatically loading and unloading machine learning models in local RAM of an information handling system to reduce RAM occupancy based on usage of those models by locally executing AI productivity tool enableable software applications.

At block 402, a machine learning model in an embodiment may be stored in “cold” data storage, such as on a solid state drive (SSD) for the information handling system, when the machine learning model is not being accessed or receiving input. For example, in an embodiment described with reference to FIG. 3, each of a plurality of machine learning models (e.g., 321, 323a, 325, 327, or 329) in an embodiment may be stored in such cold data storage, such as on a solid state drive (SSD) 320 for the information handling system, when the machine learning model (e.g., 321, 323a, 325, 327, or 329) is not being actively accessed or receiving input from a hardware processor 302 executing code instructions of an AI productivity tool enableable software application (e.g., 370). Storage in SSD 320 in an embodiment may consume fewer hardware component resources, such as hardware processor 302 resources or main memory 303 resources, which may be needed for active operations on the information handling system.

In an embodiment at block 404, a first AI productivity tool enableable software application executing code instructions via a hardware processor may request permission from the machine learning model access coordination module for a specific hardware component, such as a hardware processor, to input values into the machine learning model. For example, a hardware processor 302, such as a central processing unit (CPU) may execute code instructions of a first AI productivity tool enableable software application 370 to request permission from the machine learning model access coordination module 353 for a specific hardware processor, such as hardware processor 302 or another available hardware processor (e.g., 104 or 106 in FIG. 1), to input values into an instance of a specific machine learning model (e.g., 321, 323a, 325, 327, or 329). Thus, the hardware processor 302 identified within FIG. 3 may be a CPU, GPU, or VPU for executing the instances of the machine learning models 321, 323a, 325, 327, or 329, and may be the same or different from the hardware processor executing code instructions of the AI productivity tool enableable software application 370. As described above with respect to the example embodiments of FIG. 2, this may be the first step orchestrated by the query intent to capability determination module 352 to determine a user's intent within a received user query input in the form of any of a text or voice message recording or other input, and associate that intent with and execute a capability associated with the AI productivity tool enableable software application 370.

At block 406, a hardware processor in an embodiment may execute machine readable code instructions of the machine learning model access coordination module to instruct a machine learning model of a machine learning module to load the requested machine learning model into random access memory (RAM), such as within main memory. For example, with respect to the embodiment shown in FIG. 3 the hardware processor 302 executing machine readable code instructions of the machine learning model access coordination module 353 in an embodiment may load an instance 323b of the requested machine learning model (e.g., 323a) into random access memory (RAM), such as within main memory 303. As described herein, machine learning models may only receive input from a given AI productivity tool enableable software application 370 when loaded or stored within RAM of main memory 303. In other example embodiments, the hardware processor 302 executing machine readable code instructions of the machine learning model access coordination module 353 may load an instance of the intent recognition pipeline machine learning model 321 into main memory 303, an instance of the text embedding machine learning model 365 into main memory 303, an instance of the similarity search machine learning model 367 into main memory 303, or instances of machine learning models 329 directed at optimizing performance at the information handling system, for example, into main memory 303.

Machine readable code instructions for the machine learning model access coordination module in an embodiment at block 408 may be executed via a hardware processor to allow the specified hardware component that was identified in the request for access to the machine learning model to access and input values into the machine learning model that is now loaded into RAM. For example in FIG. 3, hardware processor 302 executing machine readable code instructions of the machine learning model access coordination module 353 in an embodiment may allow the requested hardware processor (e.g., hardware processor 302) identified in the request for access to the machine learning model (e.g., 323a) received from the AI productivity tool enableable software application 370 access to input values into the instance 323b of the machine learning model (e.g., 323a) that is now loaded into RAM in main memory 303. In order to ensure that each instance of a given machine learning model (e.g., 323b) is accessed by only one hardware processor (e.g., 302) executing code instructions for a single AI productivity tool enableable software application 370 at any given time, the hardware processor 302 executing machine readable code instructions of the machine learning model access coordination module 353 in an embodiment may issue a “ticket” allowing access to a currently loaded instance 323b of a machine learning model 323a within RAM of main memory 303 exclusively to the hardware processor 302 while executing code instructions of the AI productivity tool enableable software application 370. This “ticket” give a specified set of data locations, description, security as needed, and other data describing appropriate inputs for the loaded instance of the machine learning model in the RAM to the hardware processor executing AI productivity tool 350, the software application conversational interface 371 (or other text interface), the AI productivity tool enableable software application 370 or other software application code instructions requiring the access to the instance of the machine learning model for execution of tasks such as receiving a query input, conversion to text if applicable, text inference to a query intent vector value, and similarity determination of query intent values to stored capability intent values.

Upon issuance of such a “ticket,” the hardware processor 302 may execute code instructions of the AI productivity tool enableable software application 370 to input values (e.g., a recorded audio file or text file received from the software application conversational interface 371) to the correct input locations for the instance 323b of the ASR machine learning model 323a that has been loaded into RAM in the main memory 303. The output from the instance 323b of the ASR machine learning model 323a may be text. This text, or other text of a query directly input into a text editor, may then be inputs identified in a ticket to an instance of another machine learning model. For example, text may then be fed through text embedding machine learning model 325 of the text embedding module 365. Then the embedded text embedded as a query input intent value may be fed to inputs of an instance of the similarity search machine learning model 327 of the similarity search module 367 to identify a capability of the AI productivity tool enableable software application 370 for addressing the intended request by the user within the received user query input. Use of each of these modules 365 and 367 in an embodiment may further trigger loading instances of their respective machine learning models 325 and 327 into RAM of the main memory 303, consecutively, if not already loaded in RAM.

At block 410, a hardware processor executing machine readable code instructions for the machine learning model access coordination module may determine whether input is currently being received at the machine learning model. In some embodiments, code instructions of the first AI productivity tool enableable software application may execute to notify the machine learning model access coordination module that the first AI productivity tool enableable software application no longer needs access to the requested machine learning model. For example, upon output by the loaded instance 323b of the ASR machine learning model 323a of recognized speech within the recorded audio or text file input into the loaded machine learning model instance 323b, the hardware processor 302 may cease to input further values into the machine learning model instance 323b. The hardware processor 302 executing machine readable code instructions of the machine learning model access coordination module 353 in an embodiment may monitor such activity of the hardware processor currently assigned to usage of the loaded instance 323 of the machine learning model 323a, and can detect when such input has ceased. In some embodiments, code instructions of the first AI productivity tool enableable software application 370 may execute, via the hardware processor 302 to affirmatively notify the machine learning model access coordination module 353 that the first AI productivity tool enableable software application 370 no longer needs access to the requested instance 323b of the machine learning model 323a, thus essentially releasing the assigned “ticket.”

If it is determined via hardware processor execution of machine readable code instructions for the machine learning model access coordination module that input is currently being received at the machine learning model, this may indicate an ongoing need to keep the machine learning model loaded into RAM. In such a case, the method may proceed back to block 408, where machine readable code instructions for the machine learning model access coordination module via a hardware processor continues to allow the first AI productivity tool enableable software application to input values into the machine learning model. If it is determined by execution of machine readable code instructions for the machine learning model access coordination module via a hardware processor that input is not currently being received at the machine learning model, or that the first AI productivity tool enableable software application no longer needs access to the requested machine learning model, this may indicate that the machine learning model may be a candidate for removal from RAM to decrease hardware component resource consumption when the machine learning model is not actively in use. In such a case, the method may proceed to block 412 to begin the process of offloading the machine learning model from RAM as may be needed for maintaining a balance of RAM occupancy for improved performance of the information handling system utilizing a plurality of machine learning modules with an AI productivity tool.

In an embodiment at block 412 in which it is determined by execution of machine readable code instructions for the machine learning model access coordination module via a hardware processor that input is not currently being received at the machine learning model, or that the first AI productivity tool enableable software application no longer needs access to the requested machine learning model, code instructions for the machine learning model access coordination module may execute to start a machine learning model unloading countdown timer. For example, the hardware processor 302 executing machine readable code instructions of the machine learning model access coordination module 353 may execute to start a machine learning model unloading countdown timer. Such a machine learning model unloading countdown timer in an embodiment may be, for example, five, ten, or fifteen minutes, and may be adjustable by the user in various embodiments.

At block 414, it may again be determined by execution of machine readable code instructions for the machine learning model access coordination module via a hardware processor whether input is currently being received at the machine learning model. In some embodiments, code instructions of the first AI productivity tool enableable software application or second AI productivity tool enableable software application may execute to request access to the machine learning model prior to the expiration of the machine learning model unloading countdown timer. Loading of an instance of any given machine learning model (e.g., 321, 323a, 325, 327, or 329) into RAM of main memory 303 in an embodiment may cause a latency for loading and degrade performance of a machine learning module by requiring a plurality of seconds of processing time to load. Thus, it is preferable to retain an instance of a machine learning model (e.g., 321, 323a, 325, 327, or 329) that is likely to be used imminently to remove such a latency which may be perceptible by a user. However, storage of an instance of a machine learning model (e.g., 321, 323a, 325, 327, or 329) within RAM of main memory 303 also consumes hardware component resources (e.g., hardware processor 302 or main memory 303 resources) at a higher rate than storage in SSD 320, and may negatively impact user experience or functionality of concurrently processing software applications. As such, prior to removal of the instance 323b of the ASR machine learning model 323a from RAM in main memory 303, the hardware processor 302 executing machine readable code instructions of the machine learning model access coordination module 353 may start a machine learning model unloading countdown timer to gauge whether the hardware processor 302 executing machine readable code instructions of the AI productivity tool enableable software application 370 or any other software application requests access to the instance 323b of the ASR machine learning model 323a within a short time period after the hardware processor 302 executing machine readable code instructions of the AI productivity tool enableable software application 370 ceases inputting values into the instance 323b.

If it is determined by execution of machine readable code instructions for the machine learning model access coordination module via a hardware processor that input is currently being received at the machine learning model, or that the first AI productivity tool enableable software application or a second AI productivity tool enableable software application has requested ongoing access to the machine learning model, this may indicate an ongoing need to keep the machine learning model loaded into RAM. In such a case, the method may proceed back to block 408, where execution of machine readable code instructions for the machine learning model access coordination module via a hardware processor continues to allow the first AI productivity tool enableable software application to input values into the machine learning model. If it is determined by execution of machine readable code instructions for the machine learning model access coordination module via a hardware processor that input is not currently being received at the machine learning model, this may indicate that the machine learning model may be a candidate for removal from RAM to decrease hardware component resource consumption when the machine learning model is not actively in use. In such a case, the method may proceed to block 416 to begin the process of offloading the machine learning model from RAM.

It may be determined at block 416 in an embodiment in which the OTB AI productivity tool has determined that input is still not currently being received at the machine learning model, whether the machine learning model unloading countdown timer has elapsed. If the OTB AI productivity tool determines that input has not been received at the machine learning model during the running of the machine learning model unloading countdown timer, the method may proceed to block 420 for removal of the machine learning model from RAM to conserve hardware component resource consumption. Prior to running of the machine learning model unloading countdown timer, the OTB AI productivity tool may still consider at block 418 removal of the machine learning model from RAM, if utilization rates for one or more hardware components have reached a maximum threshold value.

At block 418, prior to expiration of the machine learning model unloading countdown timer, execution of machine readable code instructions for the machine learning model access coordination module via a hardware processor may determine whether utilization rates for one or more hardware components have reached a maximum threshold value. As another way of conserving hardware component consumption rates due to storage of instances (e.g., 323b) of machine learning models (e.g., 323a) within RAM of the main memory 303, the hardware processor 302 executing machine readable code instructions of the machine learning model access coordination module 353 may also monitor utilization rates for one or more hardware components during running of the machine learning model unloading countdown timer. For example, if, prior to expiration of the machine learning model unloading countdown timer, the hardware processor 302 executing machine readable code instructions of the machine learning model access coordination module 353 in an embodiment determines that utilization rates for one or more hardware components (e.g., hardware processor 302 or main memory 303) have reached a maximum threshold value (e.g., 90%), the hardware processor 302 executing machine readable code instructions of the machine learning model access coordination module 353 may remove the instance 323b from RAM in main memory 303 without waiting for expiration of the machine learning model unloading countdown timer. If it is determined through execution of machine readable code instructions for the machine learning model access coordination module via a hardware processor that utilization rates for one or more hardware components have reached a maximum threshold value, this may indicate a need to remove the machine learning model from RAM, even if the machine learning model unloading countdown timer has not yet expired. In such a case, the method may proceed to block 420 for removal of the machine learning model from RAM. If it is determined through execution of machine readable code instructions for the machine learning model access coordination module via a hardware processor that utilization rates for one or more hardware components have not reached a maximum threshold value, the method may proceed back to block 416 for determination as to whether the machine learning model unloading countdown timer has run. The loop between blocks 416 and 418 may be performed one or more times during running of the machine learning model unloading countdown timer in order to conserve hardware component resource utilization.

In an embodiment at block 420 in which it is determined through execution of machine readable code instructions for the machine learning model access coordination module via a hardware processor that input has not been received at the machine learning model during the running of the machine learning model unloading countdown timer, or in which it is determined through execution of machine readable code instructions for the machine learning model access coordination module via a hardware processor that utilization rates for one or more hardware components have reached a maximum threshold value, prior to expiration of the machine learning model unloading countdown timer, execution of machine readable code instructions for the machine learning model access coordination module via a hardware processor may remove the machine learning model from RAM. For example, in an embodiment in which it is determined through execution of machine readable code instructions for the machine learning model access coordination module 353 via a hardware processor 302that input is still not currently being received at the instance 323b of the ASR machine learning model 323a after the machine learning model unloading countdown timer has elapsed, machine readable code instructions for the machine learning model access coordination module 353 may execute to remove the instance 323b from RAM in main memory 303. As another example, if, prior to expiration of the machine learning model unloading countdown timer, it is determined through execution of machine readable code instructions for the machine learning model access coordination module 353 via a hardware processor 302that utilization rates for one or more hardware components (e.g., hardware processor 302 or main memory 303) have reached a maximum threshold value (e.g., 90%), machine readable code instructions for the machine learning model access coordination module 353 may execute to remove the instance 323b from RAM in main memory 303 without waiting for expiration of the machine learning model unloading countdown timer.

The method for minimizing hardware component resource consumption during local execution of machine learning models to achieve an identified user intent may then end. In such a way, the OTB AI productivity tool may balance competing needs for hardware resources by software applications and by machine learning models by automatically loading and unloading machine learning models in local RAM of an information handling system based on usage of those models by locally executing AI productivity tool enableable software applications.

The blocks of the flow diagram of FIG. 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system executing machine readable code instructions of an On the Box (OTB) Artificial Intelligence (AI) productivity tool comprising:
a solid state memory device for storing a machine learning model;
a hardware processor for executing machine readable code instructions of an AI productivity tool enableable software application;
the hardware processor for executing machine readable code instructions of a machine learning model access coordination module for the OTB AI productivity tool to receive a request for the AI productivity tool enableable software application to access the machine learning model and to store the machine learning model in a random access memory (RAM);
the hardware processor for executing code machine readable instructions of the machine learning model access coordination module to direct input values into the machine learning model by the AI productivity tool enableable software application;
the hardware processor for executing machine readable code instructions of the machine learning model access coordination module to detect that a period of time exceeding a machine learning model unloading countdown timer has elapsed since the AI productivity tool enableable software application has provided input values into the machine learning model; and
the hardware processor for executing machine readable code instructions of the machine learning model access coordination module to remove the machine learning model from RAM to decrease hardware component resource consumption at the information handling system when the machine learning model unloading countdown timer has elapsed.

2. The information handling system of claim 1 further comprising:
the hardware processor for executing machine readable code instructions of the machine learning model access coordination module to determine that the machine learning model is still in use upon receipt of a request from a second AI productivity tool enableable software application to access the machine learning model prior to expiration of the machine learning model unloading countdown timer.

3. The information handling system of claim 1 further comprising:
the hardware processor for executing machine readable code instructions of the machine learning model access coordination module to detect that a utilization rate for the hardware processor exceeds a maximum threshold value; and
the hardware processor for executing machine readable code instructions of the machine learning model access coordination module to remove the machine learning model from RAM prior to expiration of the machine learning model unloading countdown timer.

4. The information handling system of claim 1, wherein the machine learning model is an intent recognition pipeline machine learning model.

5. The information handling system of claim 1, wherein the machine learning model is a text embedding machine learning model.

6. The information handling system of claim 1, wherein the machine learning model is a similarity search machine learning model.

7. The information handling system of claim 1, wherein the machine learning model is a battery optimization machine learning model.

8. The information handling system of claim 1, wherein the machine learning model is a battery swelling machine learning model.

9. A method for On the Box (OTB) Artificial Intelligence (AI) productivity for an information handling system comprising:
receiving a request at a machine learning model access coordination module of the OTB AI productivity tool from code instructions of an AI productivity tool enableable software application executed at a first hardware processor to allow the AI productivity tool enableable software application to access a machine learning model stored on a solid state disk;
storing the machine learning model in random access memory (RAM) of a data storage device, via execution of machine readable code instructions of the machine learning model access coordination module at a second hardware processor;
providing input values into the machine learning model and receiving output values from the machine learning model, via execution of machine readable code instructions of the AI productivity tool enableable software application at the first hardware processor;
determining that the AI productivity tool enableable software application has ceased inputting values into the machine learning model, via execution of machine readable code instructions of the machine learning model access coordination module at the second hardware processor;
detecting a utilization rate for a hardware component of the information handling system exceeds a maximum threshold value, via execution of machine readable code instructions for the machine learning model access coordination module; and
removing the machine learning model from RAM, via execution of machine readable code instructions of the machine learning model access coordination module at the second hardware processor, to decrease hardware component resource consumption at the information handling system.

10. The method of claim 9 further comprising:
executing machine readable code instructions of the machine learning model access coordination module to determine that the machine learning model is still in use upon receipt of a request from a second AI productivity tool enableable software application to access the machine learning model prior to expiration of the machine learning model unloading countdown timer.

11. The method of claim 9, wherein the first hardware processor and the second hardware processor are central processing units.

12. The method of claim 9, wherein the first hardware processor is a graphics processing unit.

13. The method of claim 9, wherein the hardware component experiencing the utilization rate exceeding the maximum threshold value is the second hardware processor.

14. The method of claim 9, wherein the hardware component experiencing the utilization rate exceeding the maximum threshold value is the data storage device.

15. An information handling system operating an On the Box (OTB) Artificial Intelligence (AI) productivity tool comprising:
a first data storage device for storing a machine learning model in solid state memory;
a hardware processor for executing machine readable code instructions of a first AI productivity tool enableable software application;
the hardware processor for executing machine readable code instructions of a machine learning model access coordination module of the OTB AI productivity tool to receive a request for the first AI productivity tool enableable software application to access the machine learning model and to store the machine learning model in random access memory (RAM) of a second data storage device;
the hardware processor for executing machine readable code instructions of the machine learning model access coordination module to direct the first AI productivity tool enableable software application to provide input values into the machine learning model;
the hardware processor for executing machine readable code instructions of the machine learning model access coordination module to detect that the first AI productivity tool enableable software application has ceased inputting values into the machine learning model and to start a machine learning model unloading countdown timer; and
the hardware processor for executing machine readable code instructions of the machine learning model access coordination module to remove the machine learning model from RAM to decrease hardware component resource consumption at the information handling system when the machine learning model is unused throughout the duration of the machine learning model unloading countdown timer.

16. The information handling system of claim 15 further comprising:
the hardware processor for executing machine readable code instructions of the machine learning model access coordination module to determine that the machine learning model is unused due to receipt of an indication from the first AI productivity tool enableable software application that the first AI productivity tool enableable software application no longer requires access to the machine learning model.

17. The information handling system of claim 15 further comprising:
the hardware processor for executing machine readable code instructions of the machine learning model access coordination module to determine that the machine learning model is still in use upon receipt of a request from the first AI productivity tool enableable software application to continue accessing the machine learning model prior to expiration of the machine learning model unloading countdown timer.

18. The information handling system of claim 15 further comprising:
the hardware processor for executing machine readable code instructions of the machine learning model access coordination module to determine that the machine learning model is still in use upon receipt of a request from a second AI productivity tool enableable software application to access the machine learning model prior to expiration of the machine learning model unloading countdown timer.

19. The information handling system of claim 15 further comprising:
the hardware processor for executing machine readable code instructions of the machine learning model access coordination module to detect that a utilization rate for the hardware processor exceeds a maximum threshold value; and
the hardware processor for executing machine readable code instructions of the machine learning model access coordination module to remove the machine learning model from RAM prior to expiration of the machine learning model unloading countdown timer.

20. The information handling system of claim 15 further comprising:
the hardware processor for executing machine readable code instructions of the machine learning model access coordination module to detect that a utilization rate for the second data storage device exceeds a maximum threshold value; and
the hardware processor for executing machine readable code instructions of the machine learning model access coordination module to remove the machine learning model from RAM of the second data storage device prior to expiration of the machine learning model unloading countdown timer.
